(19) United States
(12) Patent Application Publication
(10) Pub. No.: US 2015/0058944 A1
(43) Pub. Date: Feb. 26, 2015

(54) SOCIAL DRIVEN PORTAL USING MOBILE DEVICES

(71) Applicants: Ohad Schachtel, Tel Aviv (IL); Alex Volchok, Tel Aviv (IL); Shahar Arusi, Moshav Yagal (IL)

(72) Inventors: Ohad Schachtel, Tel Aviv (IL); Alex Volchok, Tel Aviv (IL); Shahar Arusi, Moshav Yagal (IL)

(21) Appl. No.: 13/970,972

(22) Filed: Aug. 20, 2013

(51) Int. Cl. H04L 29/06

(52) U.S. Cl. CPC H04L 63/08
USPC 726/7

(57) ABSTRACT

The present disclosure describes methods, systems, and computer program products for measuring strength of a unit test. One computer-implemented method includes receiving a login request for a portal user from a mobile device, exposing one or more available widgets based, at least in part, on credentials associated with the portal user, determining that a widget identified in a received widget selection is a mobile-aware widget (MAW), receiving mobile device data responsive to a query to select a specific action associated with the MAW, the mobile device data associated with the specific action, and transmitting the received mobile device data to the MAW.

### BACKGROUND

Enterprise portals (EPs) allow integration of information, people, and processes across organizational boundaries. An EP provides a secure unified access point, often in the form of a web-based graphical user interface (GUI), and is designed to aggregate and personalize information through application-specific portals. The EP is a de-centralized content contribution, collaboration, and content management system, which keeps the information always updated. With a native application or other general access application, for example a web browser, EP users can begin work once they have been authenticated in the EP which offers a single point of access to information, enterprise applications, collaboration spaces, and services both inside and outside an organization.

EPs may present information from diverse sources on mobile or other devices in a unified and structured way, for example using HTML container documents, and provide additional services, such as dashboards, an internal search engine, e-mail, news, navigation tools, collaboration tools, and various other features. EPs are often used by enterprises for providing their employees, customers, and possibly additional users with a consistent look and feel, and access control and procedures for multiple applications, which otherwise would have been separate entities altogether.

Modern mobile devices, for example smartphones and tablet computers, have the capability to provide a rich and diverse set of data to an EP. For example, mobile device sensor data from a camera, global positioning system (GPS) sub-system, accelerometer, gyroscope, microphone, light sensor, clock, calendar, and/or other sensors/components can provide images, geographic location, orientation, movement, audio, voice commands, and/or other data. However, mechanisms to collect and add mobile device sensor data to EPs are lacking In addition, adding content to EPs typically requires customizations to each individual application executing on the EPs. The lack of an ability to collect and to add the mobile device data to the EP in a generic and efficient manner prevents enrichment of the EP with rich and timely social-type content to strengthen and personalize the EP experience for EP users.

### SUMMARY

The present disclosure relates to computer-implemented methods, computer-readable media, and computer systems for linking a mobile device to an enterprise portal. One computer-implemented method includes receiving a login request for a portal user from a mobile device, exposing one or more available widgets based, at least in part, on credentials associated with the portal user, determining that a widget identified in a received widget selection is a mobile-aware widget (MAW), receiving mobile device data responsive to a query to select a specific action associated with the MAW, the mobile device data associated with the specific action, and transmitting the received mobile device data to the MAW.

Other implementations of this aspect include corresponding computer systems, apparatuses, and computer programs recorded on one or more computer storage devices, each configured to perform the actions of the methods. A system of one or more computers can be configured to perform particular operations or actions by virtue of having software, firmware, hardware, or a combination of software, firmware, or hardware installed on the system that in operation causes or causes the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination:

A first aspect, combinable with the general implementation, further comprising associating the MAW with a portal page.

A second aspect, combinable with any of the previous aspects, further comprising configuring the MAW for one or more allowed mobile data types.

A third aspect, combinable with any of the previous aspects, further comprising registering the MAW with the social component for one or more mobile data types.

A fourth aspect, combinable with any of the previous aspects, wherein the registration can be one of a site-wide registration or a client-specific registration.

A fifth aspect, combinable with any of the previous aspects, further comprising analyzing a registration registry to determine whether to transmit the received mobile device data to the MAW.

A sixth aspect, combinable with any of the previous aspects, further comprising processing the received mobile device data prior to transmitting the mobile device data to the MAW.

The subject matter described in this specification can be implemented in particular implementations so as to realize one or more of the following advantages. First, an enterprise portal (EP) is enhanced/enabled to use/incorporate content provided by mobile device native/non-native applications. Provided content types can include images, video, global positioning system (GPS) data, accelerometer data, gyroscope data, microphone data, light sensor data, clock, calendar, and/or the like. Second, the EP enhancements provide a “bridge” between the EP and an EP user's mobile device to simplify EP author configuration of the EP and EP user uploading of mobile device content. Third, uploading personalized content is simplified/facilitated by use of readily available mobile devices and the EP user's personalized EP experiences are strengthened through use of the enhanced EP and personalized content. Fourth, the use of mobile device data helps to ensure that the enhanced EP is populated with rich, up-to-date content. Fifth, the enhanced EP takes on a social-type character to encourage user interaction and sharing of content. Other advantages will be apparent to those skilled in the art.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 is a block diagram illustrating an example distributed computing system for linking a mobile device to an enterprise portal according to an implementation.

FIGS. 2A-2C are example screenshots of user interfaces for linking a mobile device to an enterprise portal according to an implementation.

FIG. 3 is a flow chart illustrating a method for linking a mobile device to an enterprise portal according to an implementation.

Like reference numbers and designations in the various drawings indicate like elements.

### DETAILED DESCRIPTION

This disclosure generally describes computer-implemented methods, computer-program products, and systems for linking a mobile device to an enterprise portal. The following description is presented to enable any person skilled in the art to make and use the invention, and is provided in the context of one or more particular implementations. Various modifications to the disclosed implementations will be readily apparent to those skilled in the art, and the general principles defined herein may be applied to other implementations and applications without departing from scope of the disclosure. Thus, the present disclosure is not intended to be limited to the described and/or illustrated implementations, but is to be accorded the widest scope consistent with the principles and features disclosed herein.

An enterprise portal (EP) is a framework for integrating information, people, and processes across organizational boundaries. An EP provides a secure unified access point, often in the form of a web-based graphical user interface (GUI), and is designed to aggregate and personalize information through application-specific portals. The EP is a de-centralized content contribution, collaboration, and content management system, which keeps the information always updated. With a native application or other general access application, for example a web browser, EP users can begin work once they have been authenticated in the EP which offers a single point of access to information, enterprise applications, collaboration spaces, and services both inside and outside an organization.

EPs may present information from diverse sources on mobile or other devices in a unified and structured way, for example using HTML container documents, and provide additional services, such as dashboards, an internal search engine, e-mail, news, navigation tools, collaboration tools, and various other features. EPs are often used by enterprises for providing their employees, customers, and possibly additional users with a consistent look and feel, and access control and procedures for multiple applications, which otherwise would have been separate entities altogether.

Modern mobile devices, for example smartphones and tablet computers, have the capability to provide a rich and diverse set of data to an EP. For example, mobile device sensor data from a camera, global positioning system (GPS) sub-system, accelerometer, gyroscope, microphone, light sensor, clock, calendar, and/or other sensors/components can provide images, geographic location, orientation, movement, audio, voice commands, date/time, and/or other data. However, mechanisms to collect and add mobile device sensor data to EPs have been lacking. In addition, adding content to EPs typically requires customizations by authors to each individual application executing on the EPs. The lack of an ability to collect and to add the mobile device data to the EP, in other words link a mobile device to the EP, in a generic and efficient manner prevents enrichment of the EP with rich and timely social-type content to strengthen and personalize the EP experience for EP users. The following described computer-implemented methods, computer-readable media, and computer systems provide, among other things, enhanced EP functionality for linking a mobile device to an enterprise portal.

In general, the following EP enhancements permit linking of a mobile device to an enterprise portal and will be described in more detail below:

1. Provide a native application and/or enhanced non-native application (collectively a “client application”) that executes on a mobile device to permit collection of data from sensors associated with the mobile device (e.g., camera, global positioning system (GPS) sub-system, accelerometer, gyroscope, microphone, light sensor, clock, calendar, and/or the like).

2. Permit EP authors to define what can be done with an EP widget (or “widget”) by providing one or more mobile-aware widgets (MAWs) that can be selected and added by the EP author to the widget with defined mobile application abilities. For example, a MAW can be configured by the EP author as allowed (opened) to receive mobile device camera image data as well as geo-tagging data (e.g., GPS location data and time/date) from the mobile GPS sub-system and clock/calendar.

3. A social component (server-side EP add-on) acts as a bridge between the client application and the MAW. For example, in some implementations, a MAW can be configured for mobile-aware functionality with a widget menu associated with the MAW. In some implementations, the social component can also expose MAWs that can receive mobile device data to mobile devices, receive data from a client application, prepare received data for and push the prepared data to the MAWs.

4. When a MAW is available to a client application, the social component can present (e.g., in the client application) a list of open capabilities associated with the MAW based on the EP author configuration and the EP user's mobile device capabilities. The EP user can then select an action to perform associated with the MAW (e.g., upload a geo-tagged image with current date/time to the widget for display, upload a voice memo, etc.) using the client application.

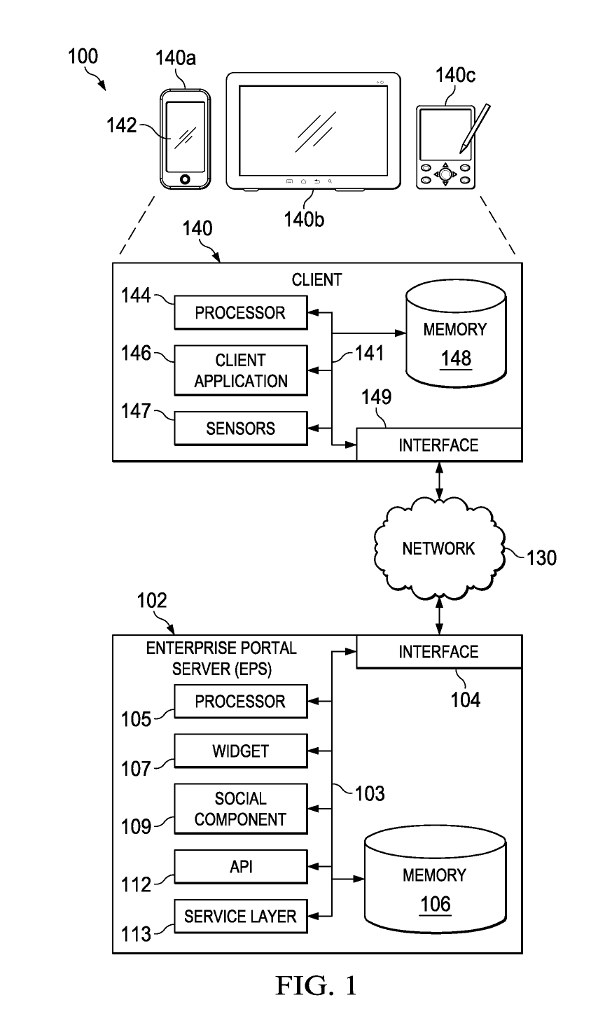

FIG. 1 is a block diagram illustrating an example distributed computing system (EDCS) 100 for linking a mobile device to an enterprise portal according to an implementation. The illustrated EDCS 100 includes or is communicably coupled with an EP server (EPS) 102 and a client 140 (an example of a mobile device as mentioned above) that communicate across a network 130. In some implementations, one or more components of the EDCS 100 may be configured to operate within a cloud-computing-based environment.

At a high level, the EPS 102 is an electronic computing device operable to receive, transmit, process, store, or manage data and information associated with the EDCS 100. According to some implementations, the EPS 102 may also include or be communicably coupled with an e-mail server, a web server, a caching server, a streaming data server, a business intelligence (BI) server, and/or other server.

In general, the EPS 102 is a server that provides at least EP capability/functionality. Specifically, the EPS 102 provides functionality for linking a mobile device to an enterprise portal associated with at least a widget 107 and/or a social component 109. The EPS 102 is responsible for receiving, among other things, EP requests and content from one or more client applications 146/sensors 147 associated with the client 140 of the EDCS 100 and responding to the received requests. In some implementations, the EPS 102 processes the requests at least in the widget 107 and/or the social component 109. In addition to requests received from the client 140, requests may also be sent to the EPS 102 from internal users, external or third-parties, other automated applications, as well as any other appropriate entities, individuals, systems, or computers. In some implementations, various requests can be sent directly to EPS 102 from a user accessing EPS 102 directly (e.g., from a server command console or by other appropriate access method).

Each of the components of the EPS 102 can communicate using a system bus 103. In some implementations, any and/or all the components of the EPS 102, both hardware and/or software, may interface with each other and/or the interface 104 over the system bus 103 using an application programming interface (API) 112 and/or a service layer 113. The API 112 may include specifications for routines, data structures, and object classes. The API 112 may be either computer-language independent or dependent and refer to a complete interface, a single function, or even a set of APIs. The service layer 113 provides software services to the EDCS 100. The functionality of the EPS 102 may be accessible for all service consumers using this service layer. Software services, such as those provided by the service layer 113, provide reusable, defined business functionalities through a defined interface. For example, the interface may be software written in JAVA, C++, or other suitable language providing data in extensible markup language (XML) format or other suitable format.

While illustrated as an integrated component of the EPS 102 in the EDCS 100, alternative implementations may illustrate the API 112 and/or the service layer 113 as stand-alone components in relation to other components of the EDCS 100. Moreover, any or all parts of the API 112 and/or the service layer 113 may be implemented as child or sub-modules of another software module, enterprise application, or hardware module without departing from the scope of this disclosure. For example, the API 112 could be integrated into the widget 107 and/or the social component 109.

The EPS 102 includes an interface 104. Although illustrated as a single interface 104 in FIG. 1, two or more interfaces 104 may be used according to particular needs, desires, or particular implementations of the EDCS 100. The interface 104 is used by the EPS 102 for communicating with other systems in a distributed environment—including within the EDCS 100—connected to the network 130; for example, the client 140 as well as other systems communicably coupled to the network 130 (whether illustrated or not). Generally, the interface 104 comprises logic encoded in software and/or hardware in a suitable combination and operable to communicate with the network 130. More specifically, the interface 104 may comprise software supporting one or more communication protocols associated with communications such that the network 130 or interface's hardware is operable to communicate physical signals within and outside of the illustrated EDCS 100.

The EPS 102 includes a processor 105. Although illustrated as a single processor 105 in FIG. 1, two or more processors may be used according to particular needs, desires, or particular implementations of the EDCS 100. Generally, the processor 105 executes instructions and manipulates data to perform the operations of the EPS 102. Specifically, the processor 105 executes the functionality required for linking a mobile device to an enterprise portal and/or associated administrative functionality related to the linking functionality.

The EPS 102 also includes a memory 106 that holds data for the EPS 102, client 140, and/or other components of the EDCS 100. Although illustrated as a single memory 106 in FIG. 1, two or more memories may be used according to particular needs, desires, or particular implementations of the EDCS 100. While memory 106 is illustrated as an integral component of the EPS 102, in alternative implementations, memory 106 can be external to the EPS 102 and/or the EDCS 100. In some implementations, memory 106 can be configured to store one or more instances of user profiles, objects and portal content (including author application configurations/rules), client 140 sensor data (none illustrated), and/or other appropriate data.

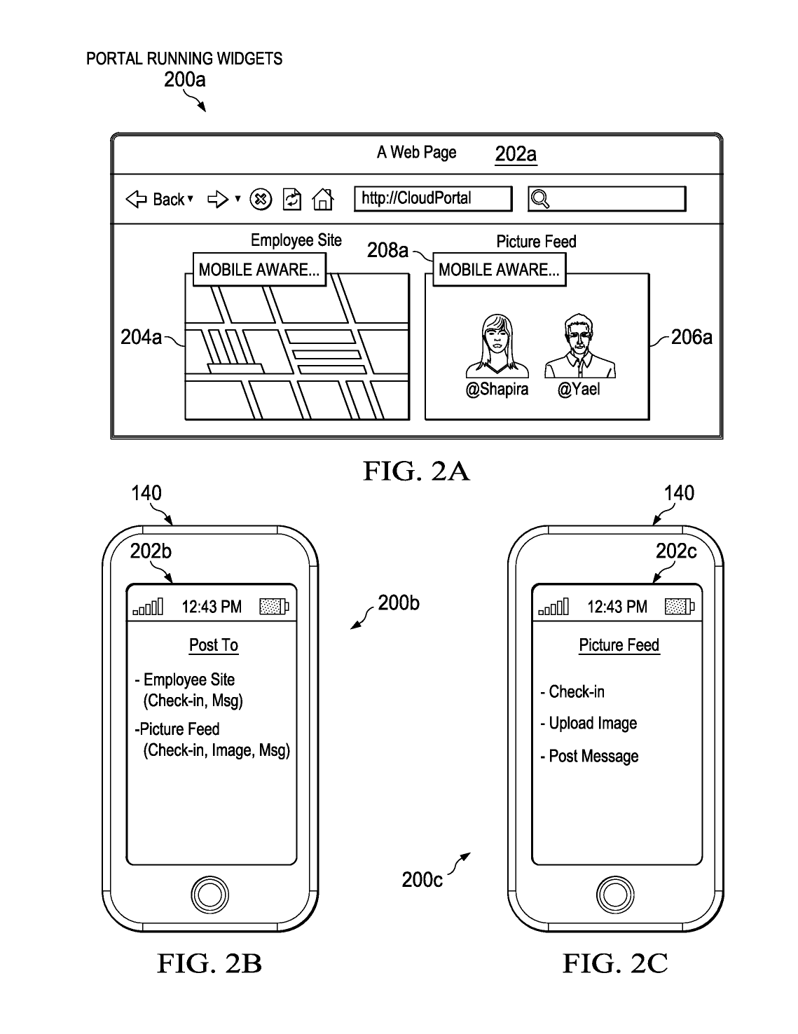

The widget 107 provides functionality associated with a particular purpose for the widget 107 to, among other things, receive, integrate, and/or display data (and in particular mobile-device, sensor-type data) from a client 140. For example, the widget 107 could be any type of application/software that receives camera images from a client 140 and displays the camera images in a carrousel type image arrangement as part of a “Picture Feed” (e.g., see FIGS. 2A-2C and associated description). The widget 107 provides content that typically is displayed in a web-based (e.g., HTML format) and can be served and displayed in a client application 146 (both native/non-native) associated with the client 140 and/or in a non-mobile client (e.g., a desktop computer, etc.).

In some implementations, the widget 107 can provide a configuration interface for an EP author. For example, when adding a widget 107 to an EP page, a “mobile aware . . . ” menu item might be displayed with the widget 107 (e.g., see FIG. 2A). Selecting the menu item can provide a configuration interface (not illustrated), allowing the EP author to configure open mobile-aware functionality for the widget 107. Hovering over the menu item could, in some implementations, present a tooltip-type pop-up with the mobile-aware functionality associated with the widget 107 for the EP author's reference. In some implementations, an EP user without authorship permissions with respect to the widget 107 could be presented with the same menu item, but selecting the menu item (or, for example hovering over the menu item) could present a tooltip-type pop-up with the mobile-aware functionality associated with the widget 107. In some implementations, selecting the menu item can present an interface allowing an EP user to request particular mobile-aware type functionality (e.g., to accept camera images and/or geo-tagging data) to be made available with respect to the widget 107. In some implementations, configuration of the widget 107 can be wholly or partially performed through use of an API associated with the widget 107 with provided configuration commands.

The widget 107 can respond to queries by the social component 109 for mobile-aware and other capabilities associated with the widget 107. For example, when an EP user submits a login request using the client 140, the social component can query the EP for what widgets 107 the EP user has access to and their capabilities. In some instances, the widget 107 can respond to a query of this type (whether directly from the social component 109 or received indirectly) to reveal its configured functionality. In some implementations, the widget 107 can receive configuration data from the social component such as user role, mobile device type, installed native/non-native applications, and the like. This received configuration data can be used by the widget to report to the social component 109 whether or not functionality normally available is available for the particular client given the received configuration data. For example, received configuration data could indicate that the client 140 is lacking a particular version of a native application and that the installed native application does not provide geo-tagging support with images. In this case, a particular widget 107 can notify the social component 109 of this issue, and the social component 109 can in turn expose the particular widget 107, but not indicate to the EP user that geo-tagging functionality with images is available with respect to the widget 107. In some implementations, the widget 107 can notify an EP user (e.g, by dialog, portal page, email, message, etc.) on the client 140 that an upgrade to a particular native application (or some other appropriate type of upgrade—including software and/or hardware) can enhance the EP user's portal experience.

In some implementations, but widget's EP author configuration can be stored in the memory 106 (not illustrated) and/or any appropriate memory in the EDCS 100. The EP author configuration can also be stored by within the widget 107 or in any other location.

Although illustrated as a single widget 107, the widget 107 may be implemented as multiple widgets 107. In addition, although illustrated as integral to the EPS 102, in alternative implementations, the widget 107 can be external to the EPS 102 and/or the EDCS 100 (e.g., wholly or partially executing on the client 140, other EPS 102 (not illustrated), etc.).

Once a particular widget 107 is launched, the particular widget 107 can be used, for example by a EP page or other component of the EDCS 100 to interactively process a task, event, or other information/content associated with the EPS 102. In some implementations, the widget 107 may be a network-based, web-based, and/or other suitable application consistent with this disclosure.

In some implementations, a particular widget 107 may operate in response to and in connection with at least one request received from other widgets 107, other components (e.g., software and/or hardware modules) associated with another EPS 102, and/or other components of the EDCS 100 (whether illustrated or not). In some implementations, the widget 107 can be accessed and executed in a cloud-based computing environment using the network 130. In some implementations, a portion of a particular widget 107 may be a web service associated with the widget 107 that is remotely called, while another portion of the widget 107 may be an interface object or agent bundled for processing by any suitable component of the EDCS 100. Moreover, any or all of a particular widget 107 may be a child or sub-module of another software module or application (not illustrated) without departing from the scope of this disclosure. Still further, portions of the particular widget 107 may be executed or accessed by a user working directly at the EPS 102, as well as remotely at a corresponding client 140. In some implementations, the EPS 102 or any suitable component of EPS 102 or the EDCS 100 can execute the widget 107.

The social component 109 is any type of application/software that provides functionality to act as a link (or bridge) between the widget 107 and the client 140. In some implementations, the social component 109 can accept registrations for data from a widget 107, receive data from a client 140, prepare the received data to transmit to the widget 107, and/or expose one or more widgets 107 that can receive mobile-device, sensor-type data from a client 140. For example, the social component 109 can receive camera images from a client 140, processes the received camera images into a new format, and transmit the processed camera images to one or more widgets 107 that have registered to receive mobile device image data.

In some implementations, the social component 109 can provide registration functionality to a widget 107 for data. For example, the above-described example “Picture Feed” widget 107 can register with the social component 109 for check-in, image, and message data received from a client 140. In some implementations, the widget 107 can register for site-level data or client-specific data. For example, a site-level content registration for image data would result in any data of the registered image type received by the social component 109 to be sent to the registered widget 107, whereas a client-specific registration would only forward image data from a particular client(s) 140. Those of skill in the art will appreciate that these two examples are only for illustrative purposes and many different forms of registration for data between the widget 107 and the social component 109 are considered to be within the scope of this disclosure. In some implementations, configuration can be wholly or partially performed through use of an API associated with the social component 109 through configuration commands.

The social component 109 exposes one or more widgets 107 to the client 140 that can receive mobile-device-type data. For example, when an EP user logs into the EP with a client 140, the social component can expose the widgets 107 that are available for EP user access and that can received mobile-device-type data (see FIGS. 2A-2C for an example). In some implementations, the social component 109 can return text, icons, images, colors, audio and/or other appropriate indicators to the client application to indicate which mobile-device-type data is supported by each widget 107.

In some implementations, the social component can query a widget 107 for mobile-aware and other capabilities associated with the widget 107. For example, when an EP user submits a login request using the client 140, the social component can query the EP for what widgets 107 the EP user has access to and their capabilities. In some implementations, the social component 109 can receive configuration data from the client 140 (e.g., user role, mobile device type, installed native/non-native applications, and the like). This received configuration data can be used by the social component 109 to expose only appropriate widget 107 functionality to a client 140. For example, received configuration data could indicate that the client 140 has an installed native application that does not provide geo-tagging support with images. In this case, a particular widget 107 can notify the social component 109 that is supports geo-tagging with images but the social component 109 can in turn expose the particular widget 107 to the client 140 but not indicate to the client 140 that geo-tagging functionality with images is available with respect to that widget 107. In some implementations, the social component 109 can notify an EP user (e.g., by dialog, portal page, email, message, etc.) on the client 140 that an upgrade to a particular native application (or some other appropriate type of upgrade—including software and/or hardware) can enhance the EP user's portal experience.

Once the social component 109 receives data from a client 140, in some implementations, the social component 109 can process the received data prior to transmitting it to one or more widgets 107. For example, the social component 109 can translate received image data from a particular digital format to an alternate format (e.g., BMP to JPG or PNG). In some implementations, the social component 109 can also cache received data and/or store the received data for access by any suitable component of the EDCS 100.

Although illustrated as a social component 109, the social component 109 may be implemented as multiple social components 109. In addition, although illustrated as integral to the EPS 102, in alternative implementations, the social component 109 can be external to the EPS 102 and/or the EDCS 100 (e.g., wholly or partially executing on the client 140, other EPS 102 (not illustrated), etc.).

Once a particular social component 109 is launched, the particular social component 109 can be used, for example by a EP page or other component of the EDCS 100 to interactively process a task, event, or other information/content associated with the EPS 102. In some implementations, the social component 109 may be a network-based, web-based, and/or other suitable application consistent with this disclosure.

In some implementations, a particular social component 109 may operate in response to and in connection with at least one request received from other social component 109, other components (e.g., software and/or hardware modules) associated with another EPS 102, and/or other components of the EDCS 100 (whether illustrated or not). In some implementations, the social component 109 can be accessed and executed in a cloud-based computing environment using the network 130. In some implementations, a portion of a particular social component 109 may be a web service associated with the social component 109 that is remotely called, while another portion of the social component 109 may be an interface object or agent bundled for processing by any suitable component of the EDCS 100. Moreover, any or all of a particular social component 109 may be a child or sub-module of another software module or application (not illustrated) without departing from the scope of this disclosure. Still further, portions of the particular social component 109 may be executed or accessed by a user working directly at the EPS 102, as well as remotely at a corresponding client 140. In some implementations, the EPS 102 or any suitable component of EPS 102 or the EDCS 100 can execute the social component 109.

The client 140 may be any computing device operable to connect to or communicate with at least the EPS 102 and provides functionality to link a mobile device to an enterprise portal. In general, the client 140 comprises an electronic computing device operable to receive, transmit, process, and store any appropriate data associated with the EDCS 100, for example, the widget 107, social component 109, and the like. More particularly, among other things, the client 140 can collect content from the client 140 and upload the collected content to the EPS 102 for integration into the widget 107 and/or memory 106. The client typically includes a processor 144, a client application 146, client sensors 147, a memory 148, and/or an interface 149 interfacing over a system bus 141.

The client application 146 is any type of application that allows the client 140 to navigate to/from, request, view, create, edit, delete, administer, and/or manipulate content associated with the EPS 102. For example, the client application 146 can present GUI displays and associated data to a user generated by the widget 107 and/or the social component 109, accept user input, and transmit the user input back to the EPS 102 for dissemination to the appropriate components of EPS 102, in particular the widget 107. In some implementations, the client application 146 can use parameters, metadata, and other information received at launch to access a particular set of data from the EPS 102 and/or other components of the EDCS 100. Once a particular client application 146 is launched, a user may interactively process a task, event, or other information associated with the EPS 102 and/or other components of the EDCS 100. For example, the client application 146 can generate and transmit a selection request for a particular portal to the EPS 102.

In some implementations, the client application 146 can be a native application. In some implementations, the client application 146 can be a general access application, for example a browser (or including) a web browser. Interactions with a widget 109 are primarily web-based, using, for example, a mobile device's web browser to perform actions on and to consume content from the enterprise widget. In some implementations, the client application 146 can be a native application that provides additional features and/or functions not normally provided on non-native client applications 146. Native applications typically are more closed in nature with tighter security and therefore allow the additional features and/or functionality that a non-native client application 146 is prohibited from providing. For example, a user could access the widget 109 using a native portal client application 146 on the mobile device (client 140) that allows access to the mobile device sensors (e.g., camera, GPS sub-system, accelerometer, gyroscope, microphones, etc.), while a generic browser accessing the widget 109 using HTML 5.0 (or other appropriate standard) would be prevented from directly accessing one or more of the mobile device sensors due to security and other concerns.

In some implementations, the client application 146 receives data on login to an EP (e.g., executing on EPS 102) as to what mobile-aware functionality is available to the EP user/client 140 depending upon the client application 146 type used to access the EP. For example, the social component 109 can analyze the type of client 140 client application 146 used to access the widget 107 and can expose widgets/associated functionality available to the particular client application 146 type. In some implementations, the widget 107 and/or the social component 109 can notify the user (e.g., with a portal page, dialog, etc.) that additional client 140 functionality can be enhanced if a native-type client application 146 is used to access the portal. In some implementations, the widget 107 and/or the social component 109 can make recommendations of client applications 146 for particular mobile device platform types (e.g., IOS, ANDROID, WINDOWS, BLACKBERRY, etc.)

In some implementations, the client application 146 can also be used perform administrative functions related to the widget 107 and/or the social component 109. For example, the widget 109 and/or the social component 109 can generate and transmit administrative pages to the client application 146 based on a particular user login.

Further, although illustrated as a single client application 146, the client application 146 may be implemented as multiple client applications in the client 140. For example, there may be a native client application and a web-based (e.g., HTML) client application, and the like depending upon the particular needs of the client 140.

Sensors 147 can include, for example, a camera, GPS sub-system, accelerometer, gyroscope, microphones, light sensor, clock, calendar, and/or the like. For example, the camera can be operable to capture images external to client 140 using a lens assembly to focus light onto an electronic image sensor (e.g., a charge coupled device (CCD)) and digitally record image information into memory 148 in various digital file formats including formats with added audio. Image data recorded by the camera 147 may be stored in memory 148, transferred over network 130 to the EPS 102 for integration into the widget 107. In another example, the GPS sub-system can provide geographic location (including altitude) information associated with the client 140. The microphone can provide audio information for messages, voice commands, memos, and the like. Other sensors 147 provide their respective functionality to the client 140.

The interface 149 is used by the client 140 for communicating with other computing systems in a distributed computing system environment, including within the EDCS 100, using network 130. For example, the client 140 uses the interface to communicate with a EPS 102 as well as other systems (not illustrated) that can be communicably coupled to the network 130. The interface 149 may be consistent with the above-described interface 104 of the EPS 102. The processor 144 may be consistent with the above-described processor 105 of the EPS 102. Specifically, the processor 144 executes instructions and manipulates data to perform the operations of the client 140, including the functionality required to send requests to the EPS 102 and to receive and process responses from the EPS 102.

The memory 148 typically stores objects and/or data associated with the purposes of the client 140 but may also be consistent with the above-described memory 106 of the EPS 102 or other memories within the EDCS 100 and be used to store data similar to that stored in the other memories of the EDCS 100 for purposes such as backup, caching, and the like.

Further, the illustrated client 140 includes a GUI 142 that interfaces with at least a portion of the EDCS 100 for any suitable purpose. For example, the GUI 142 (illustrated as associated with client 140a) may be used to view data associated with the client 140, the EPS 102, or any other component of the EDCS 100. In particular, in some implementations, the client application 146 may act as a GUI interface for the widget 107, social component 109, and/or other components of EPS 102. For example, the GUI 142 can be used, in some implementations, to select a widget 107 and transfer data collected from the sensors 147 to the widget 107.

There may be any number of clients 140 associated with, or external to, the EDCS 100. For example, while the illustrated EDCS 100 includes one client 140 communicably coupled to the EPS 102 using network 130, alternative implementations of the EDCS 100 may include any number of clients 140 suitable to the purposes of the EDCS 100. Additionally, there may also be one or more additional clients 140 external to the illustrated portion of the EDCS 100 that are capable of interacting with the EDCS 100 using the network 130. Further, the term “client” and “user” may be used interchangeably as appropriate without departing from the scope of this disclosure. Moreover, while the client 140 is described in terms of being used by a single user, this disclosure contemplates that many users may use one computer, or that one user may use multiple computers.

The illustrated client 140 (example configurations illustrated as 140a-140c) is intended to encompass any computing device such as a desktop computer, laptop/notebook computer, wireless data port, smart phone, personal data assistant (PDA), tablet computing device, one or more processors within these devices, or any other suitable processing device. For example, the client 140 may comprise a computer that includes an input device, such as a keypad, touch screen, or other device that can accept user information, and an output device that conveys information associated with the operation of the EPS 102 or the client 140 itself, including digital data, visual and/or audio information, or a GUI 142, as illustrated specifically with respect to the client 140a.

FIGS. 2A-2C are example screenshots of user interfaces 200a-200c for linking a mobile device to an enterprise portal according to an implementation.

Turning now to FIG. 2A, FIG. 2A illustrates an example EP page 202a (“A Web Page”) with two widgets 107, “Employee Site” widget 204a and “Picture Feed” widget 206a. Typically this would be the view of the EP page when viewed from a non-mobile device, for example a desktop computer. Focusing on widget 206a, it can be seen that there are two displayed pictures “@Shapira” and “@Yael.” There is also a “mobile aware . . . ” menu item 208a displayed with the widget 206a. In some implementations, hovering over menu item 208a can display a tooltip-type pop-up listing mobile-aware functionality configured by an EP author as available for the widget 206a. In some implementations, selecting the menu item 208a can provide a configuration interface (not illustrated), allowing the EP author to configure open mobile-aware functionality for the widget 206a. In some implementations, an EP user without authorship permissions with respect to the widget 206a could be presented with the same menu item, but selecting the menu item 208a (or, for example hovering over the menu item 208a) could present a tooltip-type pop-up with the mobile-aware functionality associated with the widget 206a for the EP user's reference. In some implementations, selecting the menu item 208a can present an interface allowing an EP user to request particular mobile-aware type functionality (e.g., to accept camera images and/or geo-tagging data) to be made available with respect to the widget 208a.

In some implementations, other widgets (not illustrated), including those that are non-mobile-aware could be presented in the EP page 202a and appropriate selections made available in GUI displays 202b and 202c as described below. The illustrated widgets 204a and 206a are presented to illustrate the subject matter described in this disclosure.

Turning now to FIG. 2B, FIG. 2B illustrates an example client 140 GUI display 202b presented to an EP user after login to the EP page describe in FIG. 2A. Here the GUI display 202b presents the EP user with a choice to post content to either the “Employee Site” widget 204a or the “Picture Feed” widget 206a. Note, that under each presented widget, the type of mobile-aware functionality exposed for widgets 204a and 206a is displayed. For example, widget 204a is indicated as supporting “Check-in, Msg” functionality while widget 206a is indicated as supporting “Check-in, Image, Msg” functionality. Here, widget 206a is indicated as additionally supporting receipt of images from client 140 while widget 204a does not. The EP user then makes a selection as to where to post data to.

Turning now to FIG. 2C, FIG. 2C illustrates an example client 140 GUI display 202c presented to an EP user after selection of a widget choice as presented in FIG. 2B. Here the EP user has selected “Picture Feed” in the FIG. 2B GUI. The EP user is then presented with GUI display 202c with additional options related to the “Picture Feed” widget 206a. The presented additional options are “Check-in,” “Upload Image,” and “Post Message” which corresponds to the mobile-aware functionality exposed for widget 206a in FIG. 2B. If the EP use selects one of these options, GUI functionality will be presented to allow the appropriate data to be sent to widget 206a.

The example screenshots and GUIs illustrated in FIGS. 2A-2C are presented as examples only and are not meant to cover all possible EP, widget, and/or GUI implementations but to present an example to enhance understating of the describe concepts. Various modifications to the disclosed implementations will be readily apparent to those skilled in the art, and the general principles defined herein may be applied to other implementations and applications without departing from scope of the disclosure.

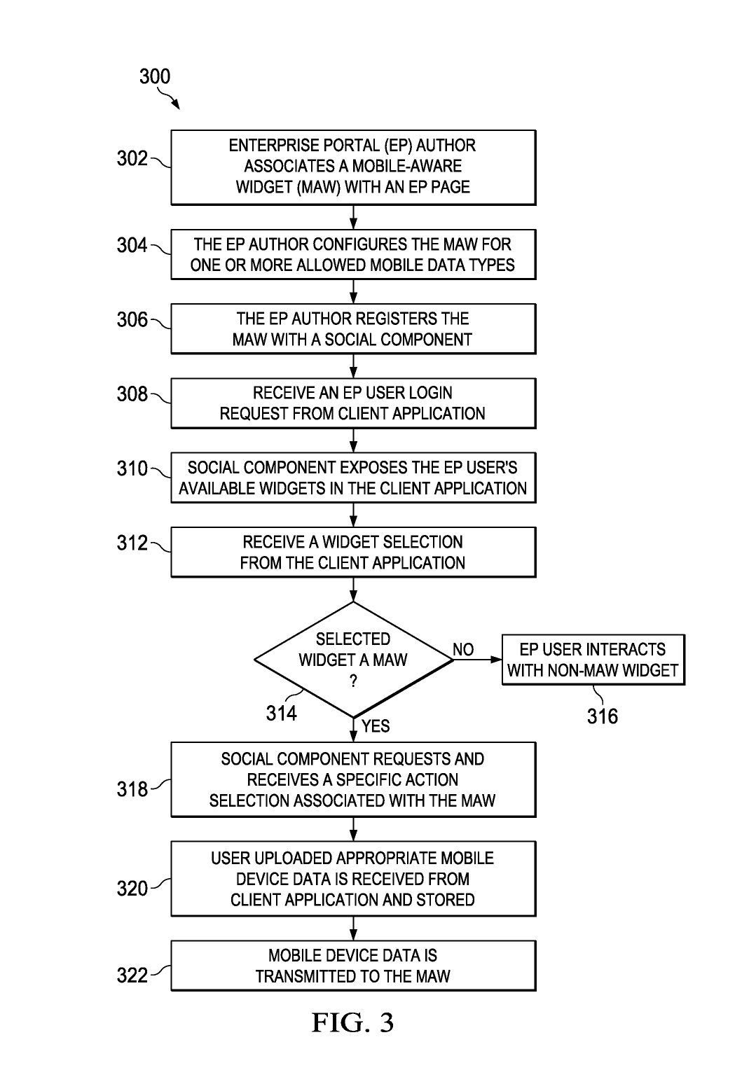

FIG. 3 is a flow chart illustrating a method 300 for linking a mobile device to an enterprise portal according to an implementation. For clarity of presentation, the description that follows generally describes method 300 in the context of FIGS. 1 and 2A-2C. However, it will be understood that method 300 may be performed, for example, by any other suitable system, environment, software, and hardware, or a combination of systems, environments, software, and hardware as appropriate. In some implementations, various steps of method 300 can be run in parallel, in combination, in loops, or in any order.

At 302, an EP author selects and associates a mobile-aware widget (MAW) with an EP page. The MAW is capable of receiving sensor data from a mobile device for use in the MAW on the EP page. For example, a city could use an EP portal page to establish a green city initiative where any city resident can register with the EP to upload images, check-in data, and messages with their mobile device related to environmental hazards/eyesores that they see or are aware of In another example, a business entity can set up a document retention EP page where employees can scan documents and enter a description and upload them to the EP using mobile devices. In this case, one or more MAWs accepting image data and messages can be set up on the EP page. From 302, method 300 proceeds to 304.

At 304, the EP author configures the MAW for one or more allowed mobile data types. In some implementations, the MAW can provide a menu or other configuration scheme to permit configuration of allowed mobile data types. In some implementations, configuration can be wholly or partially performed through use of an API associated with the MAW with provided configuration commands. For example, given the city green initiative EP portal example, one or more MAWs are specified as accepting image, check-in data, and messages can be set up on the EP page and configured appropriately. In the document retention EP example, one or more MAWs accepting image data and messages can be set up on the EP page and configured appropriately. From 304, method 300 proceeds to 306.

At 306, the EP author registers the MAW with a social component acting as a bridge between a client device/application and the MAW. The MAW registers with the social component for one or more mobile data types. In some implementations, configuration can be wholly or partially performed through use of an API associated with the social component through configuration commands. For example, given the city green initiative EP portal example, one or more MAWs can be registered with the social component which will provide any uploaded mobile data types to all EP users that have registered for the mobile data type (site-wide registration). In the document retention EP example, one or more MAWs accepting image data and messages can be registered with the social component which will only transmit data to the particular instances of MAWS associated with a particular user (client-specific registration). In other words, only the EP user and those authorized (e.g., a manager, supervisor) can view the data uploaded by the EP user using a mobile device. From 306, method 300 proceeds to 308.

At 308, an EP user login request is received from a from a client application (either native or non-native). From 308, method 300 proceeds to 310.

At 310, once authenticated by the EP, the social component exposes available widgets for the EP user in the client application. In some implementations, the exposed widgets depend upon credentials associated with the EP user, including the nature of the client application, client type (e.g., hardware, operating system, and available sensors), user role, and/or the like. For example, the social component, in some implementations, can receive data related to the EP user's login request (e.g., device identification, etc.). Based on available credentials, the social component can present a list of available MAWs/non-MAWs to the EP user in the client device as well as an indication of the mobile data types supported by the MAWs. From 310, method 300 proceeds to 312.

At 312, the social component receives a widget selection from the client application. From 312, method 300 proceeds to 314.

At 314, a determination is made as to whether the selected widget is a MAW. If it is determined that the selected widget is a MAW, method 300 proceeds to 318. If it is determined that the selected widget is not a MAW, method 300 proceeds to 316. At 316, the EP user interacts with the EP/non-MAW using the client application. After 316, method 300 stops.

At 318, the social component requests a specific action associated with the MAW. For example, a MAW may be capable of accepting check-in, image, and message data from a mobile device and would present action options “Check-in,” “Upload Image,” and “Post Message” options to the EP user in the client application. The EP user selects an action option from those presented by the social component and is presented with functionality on the mobile device to transmit mobile device data (including sensor data) to the MAW. The EP user transmits mobile device data to the MAW. From 318, method 300 proceeds to 320.

At 320, the social component receives the transmitted mobile device data from the client application. In some implementations, the social component can process the data, for example change the data format, into a form acceptable by the MAW. In some implementations, the social component analyzes its associated registry (for site-wide and client-specific registrations as described above) for MAWs registered to receive the received mobile device data. From 320, method 300 proceeds to 322.

At 322, the mobile device data is transmitted to the appropriate MAW(s). The receiving MAW(s) makes the received data available in the EP. In some implementations, the social component can process the received mobile device data prior to transmitting to the appropriate MAW(s). After 322, method 300 stops.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible, non-transitory computer-storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example, a programmable processor, a computer, or multiple processors or computers. The apparatus can also be or further include special purpose logic circuitry, e.g., a central processing unit (CPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example LINUX, UNIX, WINDOWS, MAC OS, ANDROID, IOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third-party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a CPU, a FPGA, or an ASIC.

Computers suitable for the execution of a computer program can be based on general or special purpose microprocessors, both, or any other kind of CPU. Generally, a CPU will receive instructions and data from a read-only memory (ROM) or a random access memory (RAM) or both. The essential elements of a computer are a CPU for performing or executing instructions and one or more memory devices for storing instructions and data. Generally, a computer will also include, or be operatively coupled to, receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a global positioning system (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., erasable programmable read-only memory (EPROM), electrically-erasable programmable read-only memory (EEPROM), and flash memory devices; magnetic disks, e.g., internal hard disks or removable disks; magneto-optical disks; and CD-ROM, DVD+/-R, DVD-RAM, and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), LED (Light Emitting Diode), or plasma monitor, for displaying information to the user and a keyboard and a pointing device, e.g., a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of wireline and/or wireless digital data communication, e.g., a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n and/or 802.20, all or a portion of the Internet, and/or any other communication system or systems at one or more locations. The network may communicate with, for example, Internet Protocol (IP) packets, Frame Relay frames, Asynchronous Transfer Mode (ATM) cells, voice, video, data, and/or other suitable information between network addresses.

The computing system can include clients and servers. A client and server are generally remote from each other and typically interact through a communication network. The relationship of client and server arises by virtue of computer programs running on the respective computers and having a client-server relationship to each other.

In some implementations, any or all of the components of the computing system, both hardware and/or software, may interface with each other and/or the interface using an application programming interface (API) and/or a service layer. The API may include specifications for routines, data structures, and object classes. The API may be either computer language independent or dependent and refer to a complete interface, a single function, or even a set of APIs. The service layer provides software services to the computing system. The functionality of the various components of the computing system may be accessible for all service consumers via this service layer. Software services provide reusable, defined business functionalities through a defined interface. For example, the interface may be software written in JAVA, C++, or other suitable language providing data in extensible markup language (XML) format or other suitable format. The API and/or service layer may be an integral and/or a stand-alone component in relation to other components of the computing system. Moreover, any or all parts of the service layer may be implemented as child or sub-modules of another software module, enterprise application, or hardware module without departing from the scope of this disclosure.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation and/or integration of various system modules and components in the implementations described above should not be understood as requiring such separation and/or integration in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

What is claimed is:

1. A computer-implemented method comprising:
receiving a login request for a portal user from a mobile device;
exposing one or more available widgets based, at least in part, on credentials associated with the portal user;
determining, by operation of a computer, that a widget identified in a received widget selection is a mobile-aware widget (MAW);
receiving mobile device data responsive to a query to select a specific action associated with the MAW, the mobile device data associated with the specific action; and
transmitting the received mobile device data to the MAW.

2. The method of claim 1, further comprising associating the MAW with a portal page.

3. The method of claim 2, further comprising configuring the MAW for one or more allowed mobile data types.

4. The method of claim 3, further comprising registering the MAW with a social component for one or more mobile data types.

5. The method of claim 4, wherein the registration can be one of a site-wide registration or a client-specific registration.

6. The method of claim 1, further comprising analyzing a registration registry to determine whether to transmit the received mobile device data to the MAW.

7. The method of claim 1, further comprising processing the received mobile device data prior to transmitting the mobile device data to the MAW.

8. A non-transitory, computer-readable medium storing computer-readable instructions executable by a computer and operable to:
receive a login request for a portal user from a mobile device;
expose one or more available widgets based, at least in part, on credentials associated with the portal user;
determine that a widget identified in a received widget selection is a mobile-aware widget (MAW);
receive mobile device data responsive to a query to select a specific action associated with the MAW, the mobile device data associated with the specific action; and
transmit the received mobile device data to the MAW.

9. The medium of claim 8, further operable to associate the MAW with a portal page.

10. The medium of claim 9, further operable to configure the MAW for one or more allowed mobile data types.

11. The medium of claim 10, further operable to register the MAW with a social component for one or more mobile data types.

12. The method of claim 11, wherein the registration can be one of a site-wide registration or a client-specific registration.

13. The medium of claim 8, further operable to analyze a registration registry to determine whether to transmit the received mobile device data to the MAW.

14. The medium of claim 8, further operable to process the received mobile device data prior to transmitting the mobile device data to the MAW.

15. A system, comprising:
a memory configured to store widgets;
at least one computer interoperably coupled with the memory and configured to:
receive a login request for a portal user from a mobile device;
expose one or more available widgets based, at least in part, on credentials associated with the portal user;
determine that a widget identified in a received widget selection is a mobile-aware widget (MAW);
receive mobile device data responsive to a query to select a specific action associated with the MAW, the mobile device data associated with the specific action; and
transmit the received mobile device data to the MAW.

16. The system of claim 15, further configured to associate the MAW with a portal page.

17. The system of claim 16, further configured to configure the MAW for one or more allowed mobile data types.

18. The system of claim 17, further configured to register the MAW with a social component for one or more mobile data types.

19. The system of claim 18, wherein the registration can be one of a site-wide registration or a client-specific registration.

20. The system of claim 15, further configured to analyze a registration registry to determine whether to transmit the received mobile device data to the MAW.

21. The system of claim 15, further configured to process the received mobile device data prior to transmitting the mobile device data to the MAW.
